(19) United States
(12) Patent Application Publication
(10) Pub. No.: US 2008/0274376 A1
(43) Pub. Date: Nov. 6, 2008

(54) SLURRY COMPOSITION FOR CERAMIC GREEN SHEETS AND METHOD FOR PRODUCING THE SAME AND MULTILAYER CERAMIC ELECTRONIC COMPONENT AND METHOD FOR PRODUCING THE SAME

(75) Inventor: Kazuo KISHIDA, Otsu-shi (JP)

Correspondence Address: MURATA MANUFACTURING COMPANY, LTD.;C/O KEATING & BENNETT, LLP, 1800 Alexander Bell Drive, SUITE 200, Reston, VA, 20191, US

(73) Assignee: MURATA MANUFACTURING CO., LTD., Nagaokakyo-shi (JP)

(21) Appl. No.: 12/176,520

(22) Filed: Jul. 21, 2008

Related U.S. Application Data
(63) Continuation of application No. PCT/JP2007/070631, filed on Oct. 23, 2007.

(30) Foreign Application Priority Data
Oct. 24, 2006 (JP) 2006-288503

(51) Int. Cl. B32B 9/00; C03B 29/00; C04B 35/00

(52) U.S. Cl. 428/699; 156/89.16; 501/1

(57) ABSTRACT

A slurry composition includes a ceramic raw powder including boron and an alkaline earth metal, an acrylic binder component, a β-diketone, functioning as a chelating agent, and an organic solvent. The content of the β-diketone is about 0.020 to about 0.040 times by weight the total content of boron and the alkaline earth metal in the ceramic raw powder. The slurry composition is advantageous for use in forming, for example, ceramic layers for a multilayer ceramic substrate.

### BACKGROUND OF THE INVENTION

1. Field of the Invention

The present invention relates to slurry compositions for ceramic green sheets and methods for producing the compositions and multilayer ceramic electronic components and methods for producing the components. In particular, the present invention relates to an organic solvent-based slurry composition for ceramic green sheets which includes a ceramic raw powder including boron and an alkaline earth metal and a binder component and a method for producing the composition and a multilayer ceramic electronic component produced using the slurry composition and a method for producing the component.

2. Description of the Related Art

Ceramic green sheets are formed when, for example, multilayer ceramic electronic components such as multilayer ceramic substrates and multilayer ceramic capacitors, are produced, and a slurry composition is prepared to form such ceramic green sheets. The ceramic green sheets are formed by forming the slurry composition into sheets.

To form high quality ceramic green sheets, it is important that the slurry composition remains ungelled. The slurry composition, however, often tends to gel over time. Techniques for preventing gelling of a slurry composition are discussed in, for example, Japanese Unexamined Patent Application Publication Nos. 6-96993 and 7-187809.

Japanese Unexamined Patent Application Publication No. 6-96993 discloses a technique of preparing a slurry composition by adding an acrylic acid polymer binder to a mixture of a solvent, a ceramic raw powder including an alkaline earth metal, and a chelating agent that forms a complex with the alkaline earth metal.

Japanese Unexamined Patent Application Publication No. 6-96993 assumes that the alkaline earth metal included in the ceramic raw powder is the causative substance of gelling. To prevent gelling, therefore, the chelating agent is added to form a complex with the alkaline earth metal.

In Japanese Unexamined Patent Application Publication No. 6-96993, water is used in examples as the solvent added to the slurry composition, and chelating agents such as ethylenediaminetetraacetic acid (EDTA), diethyleneaminepentaacetic acid (DTPA), nitrilotriacetic acid (NTA), and triethylenetetrahexaacetic acid (TTHA) are used.

Japanese Unexamined Patent Application Publication No. 7-187809, on the other hand, discusses a method of preparing a slurry composition by adding poly(vinyl alcohol) to a mixture of water, a ceramic raw powder including boron oxide, and a polyalcohol.

Japanese Unexamined Patent Application Publication No. 7-187809 assumes that a reaction of poly(vinyl alcohol) with the boron oxide contained in the ceramic raw powder is the cause of gelling. To prevent gelling, the polyalcohol is added to the ceramic raw powder including boron oxide in advance before poly(vinyl alcohol) is added.

In Japanese Unexamined Patent Application Publication No. 7-187809, polyalcohols, such as D-glucitol and D-mannitol, are used.

The slurry compositions discussed in Japanese Unexamined Patent Application Publication Nos. 6-96993 and 7-187809 both include water as a solvent.

Another attempt has been made to prepare a slurry composition using a ceramic raw powder including boron, a butyral binder component, such as poly(vinyl butyral), and an organic solvent. In this case, however, boron leaches from the ceramic raw powder into the organic solvent, causing a crosslinking reaction with the butyral binder component. This often leads to gelling of the slurry composition and increased viscosity through a process from a step of dispersion treatment for preparing the slurry composition to a step of forming ceramic green sheets. Such a composition cannot be used to stably form high quality ceramic green sheets.

One approach to the above-described problem is the application of the gelling-preventing techniques discussed in Japanese Unexamined Patent Application Publication Nos. 6-96993 and 7-187809.

However, the slurry compositions subjected to the gelling-preventing measures discussed in Japanese Unexamined Patent Application Publication Nos. 6-96993 and 7-187809 both include water as a solvent. These measures cannot be used to prevent gelling of an organic solvent-based slurry composition because the chelating agent added to prevent gelling in Japanese Unexamined Patent Application Publication No. 6-96993 and the polyalcohol added to prevent gelling in Japanese Unexamined Patent Application Publication No. 7-187809 both have low solubility in organic solvents.

Japanese Unexamined Patent Application Publication No. 2005-139034 discloses a slurry composition that solves the above-described problem. The slurry composition discussed in Japanese Unexamined Patent Application Publication No. 2005-139034 includes a boron-containing ceramic raw powder, a butyral binder component, such as poly(vinyl butyral), which has hydroxy groups, an organic solvent, and a β-diketone, functioning as a chelating agent, and the content of the β-diketone is 0.5 to 5.0 times by weight that of boron.

The slurry composition discussed in Japanese Unexamined Patent Application Publication No. 2005-139034 can be favorably prevented from gelling or having increased viscosity because boron leaching into the organic solvent reacts selectively with the β-diketone, which is compatible with the organic solvent, so that a crosslinking reaction of boron with the butyral binder component is prevented.

For the slurry composition discussed in Japanese Unexamined Patent Application Publication No. 2005-139034, however, the content of the β-diketone, functioning as a chelating agent, is specified based on the content of boron. In actuality, other ionized components leaching from the ceramic raw powder are also responsible for gelling, and its cause is not limited to boron. In addition, any alkaline earth metal included in the ceramic raw powder also leaches as one such ionized component. Nevertheless, Japanese Unexamined Patent Application Publication No. 2005-139034 does not take the presence of the alkaline earth metal into consideration, and the content of the β-diketone specified therein may not be satisfactory.

Furthermore, the butyral binder component, such as a poly(vinyl butyral), included as a binder component in the slurry composition discussed in Japanese Unexamined Patent Application Publication No. 2005-139034 has relatively low degreasability. If ceramic green sheets formed of the slurry composition are used to produce a multilayer ceramic electronic component, they are susceptible to delamination and also require extended firing time which increase costs.

### SUMMARY OF THE INVENTION

To overcome the problems described above, preferred embodiments of the present invention provide an organic solvent-based slurry composition for ceramic green sheets which includes a ceramic raw powder including boron and an alkaline earth metal and a binder component, which is prevented from gelling, and which has superior degreasability, and also provide a method for producing the composition.

Another preferred embodiment of the present invention provides a ceramic green sheet formed of the above slurry composition.

Another preferred embodiment of the present invention provides a multilayer ceramic electronic component produced using the above slurry composition and a method for producing the component.

A slurry composition according to a preferred emboidment of the present invention includes a ceramic raw powder including boron and an alkaline earth metal, a binder component, and an organic solvent. To overcome the above-described problems, the slurry composition includes an acrylic binder component as the binder component and further includes a β-diketone as a chelating agent. The content of the β-diketone is about 0.020 to about 0.040 times by weight the total content of boron and the alkaline earth metal in the ceramic raw powder.

Preferred embodiments of the present invention are further directed to a ceramic green sheet formed of the above-described slurry composition for ceramic green sheets.

A production method according to a preferred embodiment of the present invention includes the steps of dispersing the ceramic raw powder including boron and the alkaline earth metal and the β-diketone, functioning as a chelating agent, and dispersing the acrylic binder component.

The method for producing a multilayer ceramic electronic component preferably includes the steps of preparing a plurality of ceramic green sheets as described above, laminating the ceramic green sheets on top of one another to form an unsintered ceramic laminate, and firing the unsintered ceramic laminate.

The method for producing a multilayer ceramic electronic component preferably includes the steps of preparing first ceramic green sheets as described above, preparing a second ceramic green sheet including a ceramic powder that is not substantially sintered at the sintering temperature of the first ceramic green sheets, laminating the first ceramic green sheets on top of one another with the second ceramic green sheet provided on one of the first ceramic green sheets to form an unsintered composite laminate, and firing the unsintered composite laminate.

In the method for producing a multilayer ceramic electronic component, the second ceramic green sheet may be provided as an outermost layer of the unsintered composite laminate, and the method may further include a step of removing an unsintered outer constraining layer defined by the second ceramic green sheet provided as the outermost layer after the step of firing the unsintered composite laminate.

The multilayer ceramic electronic component according to preferred embodiments of the present invention includes a plurality of ceramic layers stacked on top of one another, and the ceramic layers are formed by sintering ceramic green sheets as described above.

The multilayer ceramic electronic component according to a preferred embodiment of the present invention may further include a constraining layer provided on one of the ceramic layers. The constraining layer includes a ceramic powder that is not substantially sintered at the sintering temperature of the ceramic green sheets.

Preferred embodiments of the present invention can provide a slurry composition that is favorably prevented from gelling or having increased viscosity. This is because boron and the alkaline earth metal leaching into the organic solvent react selectively with the β-diketone, which is compatible with the organic solvent, so that a crosslinking reaction of boron and the alkaline earth metal with the acrylic binder component is prevented.

In addition, the slurry composition according to preferred embodiments of the present invention can reliably provide a gelling-preventing effect because the content of the β-diketone, functioning as a chelating agent, is specified as a weight ratio with respect to the total content of components responsible for gelling, including not only boron but also the alkaline earth metal.

Furthermore, the slurry composition according to preferred embodiments of the present invention, including the acrylic binder component, has higher degreasability than one including a butyral binder component. With the slurry composition, therefore, delamination is suppressed, and the firing time is reduced.

The use of the slurry composition enables production of a high quality multilayer ceramic substrate.

In the method for producing a multilayer ceramic electronic component according to preferred embodiments of the prsent invention, particularly, a multilayer ceramic electronic component having high accuracy in terms of dimension and shape can be produced by preparing first ceramic green sheets according to preferred embodiments of the prsent invention, preparing a second ceramic green sheet including a ceramic powder that is not substantially sintered at the sintering temperature of the first ceramic green sheets, laminating the first ceramic green sheets on top of one another with the second ceramic green sheet provided on one of the first ceramic green sheets to form an unsintered composite laminate, and firing the unsintered composite laminate.

Other features, elements, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a set of sectional views illustrating a first preferred embodiment of a method for producing a multilayer ceramic substrate as an example of a multilayer ceramic electronic component using a slurry composition according to preferred embodiments of the present invention.

FIG. 2 is a sectional view showing surface-mounted components mounted on a multilayer ceramic substrate shown in FIG. 1(3).

FIG. 3 is a set of sectional views for illustrating a second preferred embodiment of the method for producing a multilayer ceramic substrate as an example of a multilayer ceramic electronic component using the slurry composition according to preferred embodiments of the present invention.

FIG. 4 is a sectional view for illustrating a third preferred embodiment of the method for producing a multilayer ceramic substrate as an example of a multilayer ceramic electronic component using the slurry composition according to preferred embodiments of the present invention.

### DETAILED DESCRIPTION OF PREFERRED EMBODIMENTS

A slurry composition for ceramic green sheets according to preferred embodiments of the present invention is produced as follows.

First, a ceramic raw powder including boron and an alkaline earth metal, an organic solvent, and a β-diketone, functioning as a chelating agent, are sufficiently mixed until the ceramic raw powder and the β-diketone are dispersed in the organic solvent.

An acrylic binder component is then added to the mixture, which is further mixed, thus preparing an intended slurry composition.

The acrylic binder component may be added in multiple steps after the ceramic raw powder and the β-diketone are dispersed in the organic solvent. If necessary, other additives, such as a plasticizer, may be added to the slurry composition.

If the β-diketone is added at the same time as or after the addition of the acrylic binder component. However, a crosslinking reaction of boron and the alkaline earth metal with the acrylic binder component proceeds to some extent before the β-diketone works, thus causing gelling.

In the production method, the content of the β-diketone is preferably about 0.020 to about 0.040 times by weight that of boron and the alkaline earth metal in the ceramic raw powder, for example. The content of boron and the alkaline earth metal is expressed on an element basis. The β-diketone used may be, for example, acetylacetone, propionylacetone, or butyrylacetone, and acetylacetone is preferable.

The acrylic binder component used may be, for example, an acrylic acid ester copolymer, a methacrylic acid ester copolymer, an alkyl acrylate copolymer, or an alkyl methacrylate copolymer.

Next, experimental examples performed to determine the specification conditions of the slurry composition for ceramic green sheets and the method for producing the composition according to this invention will be described.

### EXPERIMENTAL EXAMPLE 1

A ceramic raw powder including boron and an alkaline earth metal was prepared. This ceramic raw powder included about 40% by weight of alumina powder and about 60% by weight of glass (SiO₂:Al₂O₃:CaO:B₂O₃=59:6:27:8). Then, about 200 g of the ceramic raw powder including boron and the alkaline earth metal (the total content of boron (B) and the alkaline earth metal (Ca) was about 26.2 g), about 3.0 g of a dispersant, about 5.0 g of a plasticizer, and acetylacetone, used as the β-diketone, were subjected to primary mixing in about 200 g of a toluene-ethanol (1:1) mixed solvent for about 16 hours. Samples were prepared having different weight ratios of acetylacetone to the total content of boron and the alkaline earth metal in the ceramic raw powder, as shown in the column “Acetylacetone content” of Table 1.

Next, about 30 g of an acrylic binder solution including about 50% by weight of acrylic component was added to the primary mixtures. The mixtures were then subjected to secondary mixing for about 16 hours, thus preparing slurry compositions for the samples.

The slurry compositions thus prepared were formed into sheets with an area of about 100 mm× about 100 mm and a thickness of about 30 μm, thus forming substrate ceramic green sheets.

In addition, about 2.0 g of a dispersant and about 5.0 g of a plasticizer were added to about 200 g of alumina powder, and they were subjected to primary mixing in about 200 g of a toluene-ethanol (1:1) mixed solvent for about one hour. Then, an acrylic binder solution including about 50% by weight of acrylic component was added to the primary mixture so that the acrylic component was contained in an amount of about 13% by weight of the amount of alumina powder, and they were subjected to secondary mixing for about 16 hours, thus preparing a slurry composition for constraining layers. The slurry composition thus prepared was formed into sheets with an area of about 100 mm× about 100 mm and a thickness of about 100 μm, thus forming constraining-layer alumina green sheets.

Thirty substrate ceramic green sheets were laminated on top of one another, and three constraining-layer alumina green sheets were laminated on each of the top and bottom of the laminate. In this manner, ceramic laminates including capacitors (distance between electrodes for providing capacitance: about 15 μm) were formed. These ceramic laminates were fired at a firing temperature of about 900° C. for about 30 minutes to produce multilayer ceramic substrates. The samples were evaluated for capacitance variation. The results are shown in Table 1.

TABLE 1

| Sample | Acetylacetone content | Slurry viscosity | Surface roughness | Capacitance |
|---|---|---|---|---|
| No. | (weight ratio) | (mPa · s) | (μm) | variation (3C V; %) |
| 1 | 0 | 220 | 4.82 | 9.33 |
| 2 | 0.015 | 180 | 3.25 | 6.21 |
| 3 | 0.020 | 101 | 0.31 | 1.28 |
| 4 | 0.030 | 94 | 0.18 | 0.92 |
| 5 | 0.040 | 98 | 0.26 | 1.12 |
| 6 | 0.060 | 215 | 3.84 | 6.51 |

Table 1 shows that Samples 3 to 5, having acetylacetone contents within the range of about 0.020 to about 0.040 times by weight, had sufficiently low slurry viscosity, low surface roughness, and small capacitance variations at 3C V, namely, less than about 2%. These results demonstrate that the gelling-preventing effect of acetylacetone was sufficiently provided.

In contrast, Samples 1 and 2, having acetylacetone contents of less than about 0.020 times by weight, had surface roughnesses of more than about 3 μm and capacitance variations of more than about 5% at 3C V. This is because the amount of acetylacetone was insufficient to mask leached ions, thus leading to gelling and a tendency to have increased viscosity.

In addition, Sample 6, having an acetylacetone content of more than about 0.040 times by weight, showed a tendency to have increased viscosity and had a surface roughness of more than about 3 μm and a capacitance variation of more than about 5% at 3C V. This is because acetylacetone combined not only with the leached ions but also with other elements included in the ceramic raw powder to form a network.

### EXPERIMENT EXAMPLE 2

A ceramic raw powder including boron and an alkaline earth metal was prepared. This ceramic raw powder included about 40% by weight of alumina powder and about 60% by weight of glass (SiO₂:Al₂O₃:CaO:B₂O₃=59:6:27:8). Then, about 200 g of the ceramic raw powder containing boron and the alkaline earth metal (the total content of boron (B) and the alkaline earth metal (Ca) was about 26.2 g), about 3.0 g of a dispersant, about 5.0 g of a plasticizer, and acetylacetone, used as the β-diketone, were subjected to primary mixing in about 200 g of a toluene-ethanol (1:1) mixed solvent for about 16 hours. At this time, different weight ratios of acetylacetone to the total content of boron and the alkaline earth metal in the ceramic raw powder were selected, as shown in the column “Acetylacetone content” of Table 2.

Next, an acrylic binder solution including about 50% by weight of acrylic component or a butyral binder solution including about 20% by weight of butyral component was added to the primary mixtures in different amounts, as shown in Table 2. The mixtures were then subjected to secondary mixing for about 16 hours, thus preparing slurry compositions for samples.

The slurry compositions thus prepared were formed into sheets with an area of about 100 mm× about 100 mm and a thickness of about 30 μm, thus forming substrate ceramic green sheets.

In addition, about 2.0 g of a dispersant and about 5.0 g of a plasticizer were added to about 200 g of alumina powder, and they were subjected to primary mixing in about 200 g of a toluene-ethanol (1:1) mixed solvent for about one hour. Then, an acrylic binder solution including about 50% by weight of acrylic component was added to the primary mixture so that the acrylic component was contained in an amount of about 13% by weight of the amount of alumina powder, and they were subjected to secondary mixing for about 16 hours, thus preparing a slurry composition for constraining layers. The slurry composition thus prepared was formed into sheets with an area of about 100 mm× about 100 mm and a thickness of about 100 μm, thus forming constraining-layer alumina green sheets.

Thirty substrate ceramic green sheets were laminated on top of one another, and three constraining-layer alumina green sheets were laminated on each of the top and bottom of the laminate. In this manner, ceramic laminates including capacitors (distance between electrodes for providing capacitance: about 15 μm) were formed. These ceramic laminates were fired at a firing temperature of about 900° C. for about 30 minutes to produce multilayer ceramic substrates. The multilayer ceramic substrates of the samples were evaluated for delamination by scanning acoustic microscopy (C-SAM) and polished section observation. Table 2 shows the number of samples that caused delamination among ten samples for each type.

TABLE 2

| Sample | | Binder content | Acetylacetone content | Delamination |
|---|---|---|---|---|
| No. | Type of binder | (% by weight) | (weight ratio) | (number of samples) |
| 11 | Acrylic | 11.0 | 0.020 | 0 |
| 12 | Acrylic | 13.0 | 0.030 | 0 |
| 13 | Acrylic | 15.0 | 0.030 | 0 |
| 14 | Acrylic | 17.0 | 0.040 | 0 |
| 15 | Butyral | 8.0 | 0.020 | 1 |
| 16 | Butyral | 10.0 | 0.030 | 2 |
| 17 | Butyral | 12.0 | 0.040 | 3 |

Table 2 shows that Samples 11 to 14, including the acrylic binder, caused no delamination, whereas Samples 15 to 17, including the butyral binder, caused delamination even though their acetylacetone contents fell within the range of about 0.020 to about 0.040 times by weight.

The slurry composition for ceramic green sheets according to preferred embodiments of the present invention is advantageous for use in the production of a multilayer ceramic electronic component as described below.

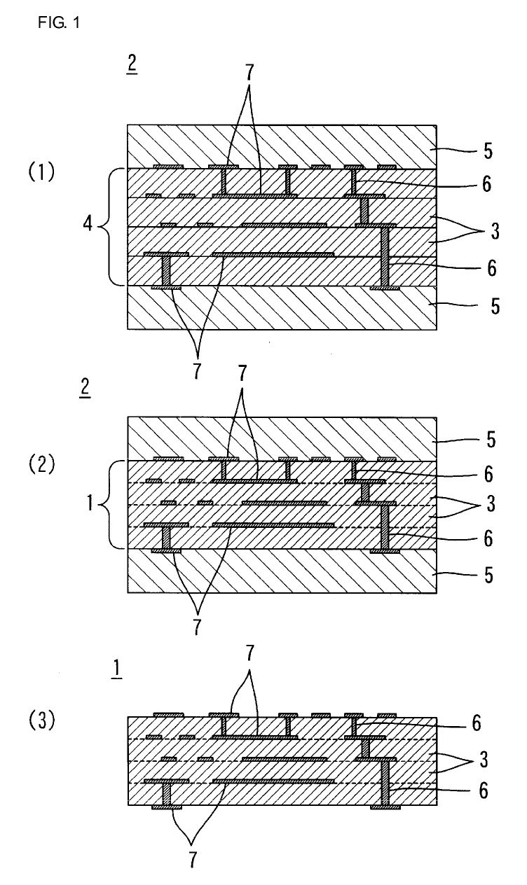

FIG. 1 illustrates a method for producing a multilayer ceramic substrate as an example of a multilayer ceramic electronic component. FIG. 1(3) is a sectional view of a resultant multilayer ceramic substrate 1. The multilayer ceramic substrate 1 is produced through the steps shown in FIGS. 1(1) and 1(2).

Referring to FIG. 1(1), first, an unsintered composite laminate 2 is formed. This unsintered composite laminate 2 includes a ceramic laminate 4 having a multilayer structure of ceramic layers 3 and outer constraining layers 5 provided on the two main surfaces of the ceramic laminate 4 to define the outermost layers of the unsintered composite laminate 2.

To form the unsintered composite laminate 2, first ceramic green sheets defining the ceramic layers 3 and second ceramic green sheets defining the outer constraining layers 5 are prepared. The first ceramic green sheets are formed of the slurry composition according to preferred embodiments of the present invention. The second ceramic green sheets include a ceramic powder that is not substantially sintered at the sintering temperature of the first ceramic green sheets. The ceramic powder used is, for example, alumina powder or a zirconia powder.

Next, unsintered interlayer connection conductors 6 are formed by forming through-holes in some of the first ceramic green sheets and filling them with conductive paste. In addition, unsintered in-plane conductors 7 are formed on main surfaces of some of the first ceramic green sheets by printing with conductive paste. The in-plane conductors 7 disposed on the outer surfaces of the ceramic laminate 4 may instead be formed on the second ceramic green sheets, which define the outer constraining layers 5.

Next, the first ceramic green sheets are laminated in a predetermined order to form the unsintered ceramic laminate 4. In the unsintered ceramic laminate 4, the first ceramic green sheets define the ceramic layers 3. In addition, the second ceramic green sheets are provided on the two main surfaces of the unsintered ceramic laminate 4 to form the composite laminate 2, with the ceramic laminate 4 sandwiched between the outer constraining layers 5. The composite laminate 2 is then pressed in the lamination direction.

Next, the composite laminate 2 is fired at a temperature at which the outer constraining layers 5 are not sintered but the unsintered ceramic layers 3 and the unsintered interlayer connection conductors 6 and in-plane conductors 7 are sintered. The state after the firing is shown in FIG. 1(2), where elements that are equivalent to those shown in FIG. 1(1) are denoted by the same reference numerals.

As a result of the firing step, the ceramic layers 3, the interlayer connection conductors 6, and the in-plane conductors 7, defining the ceramic laminate 4, are sintered, but the outer constraining layers 5 of the composite laminate 2 are not substantially sintered. Thus, the ceramic laminate 4 is sintered between the outer constraining layers 5, so that the multilayer ceramic substrate 1 is obtained. The differences between FIGS. 1(1) and 1(2) show that the fired multilayer ceramic substrate 1 has been prevented from contracting in the main-surface direction as compared with the unsintered ceramic laminate 4 under the effect of the outer constraining layers 5. In the thickness direction, the multilayer ceramic substrate 1 has contracted as compared to the unsintered ceramic laminate 4.

Next, the unsintered outer constraining layers 5 are removed from the fired composite laminate 2, thus obtaining the sintered multilayer ceramic substrate 1, as shown in FIG. 1(3). The unsintered outer constraining layers 5 can be readily removed by sand blasting, for example, because they have become porous due to volatilization of organic components contained before the firing.

In the above-described preferred embodiment, the multilayer ceramic substrate 1 is produced using the outer constraining layers 5 to achieve high accuracy in terms of dimension and shape. If this advantage is not required, the multilayer ceramic substrate 1 may be produced without using the outer constraining layers 5. Alternatively, only one outer constraining layer 5 may be provided on either main surface of the ceramic laminate 4.

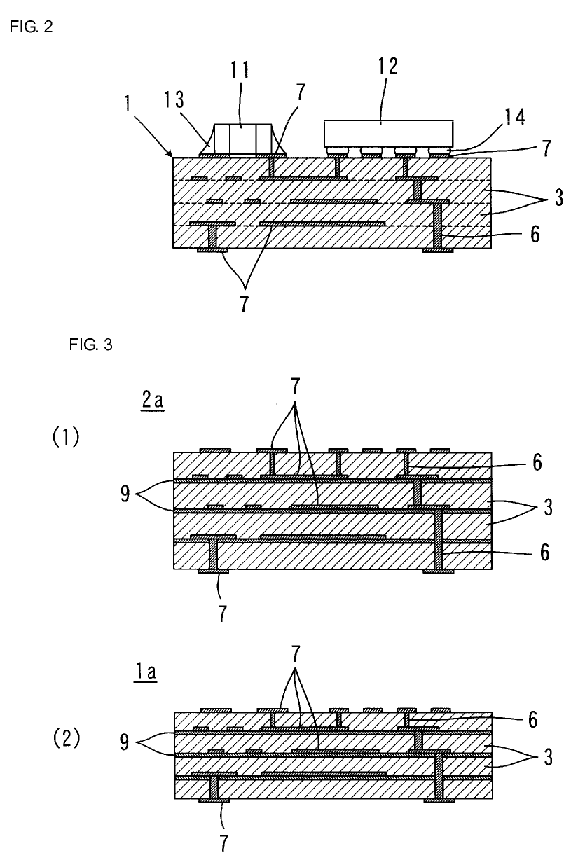

Referring to FIG. 2, surface-mounted components 11 and 12 are optionally mounted on the top main surface of the resultant multilayer ceramic substrate 1. The surface-mounted component 11 may be, for example, a chip capacitor electrically connected to the in-plane conductors 7 located on the outer surface with solder joints 13. The other surface-mounted component 12 may be, for example, a semiconductor chip electrically connected to the in-plane conductors 7 positioned on the outer surface with solder bumps 14.

FIG. 3 illustrates another preferred embodiment of the method for producing a multilayer ceramic substrate as an example of a multilayer ceramic electronic component. FIG. 3(2) is a sectional view of a resultant multilayer ceramic substrate 1a, and FIG. 3(1) is a sectional view of an unsintered composite laminate 2a prepared for production of the multilayer ceramic substrate 1a. In FIG. 3, elements that correspond to those shown in FIG. 1 are denoted by the same reference numerals, and a redundant description will be omitted.

Referring to FIG. 3(1), the unsintered composite laminate 2a includes unsintered ceramic layers 3 and unsintered interlayer constraining layers 9 formed along the interfaces between the ceramic layers 3. As in the preferred embodiment shown in FIG. 1, the ceramic layers 3 are defined by the first ceramic green sheets, which are formed of the slurry composition according to preferred embodiments of the present invention. Like the outer constraining layers 5 of the preferred embodiment shown in FIG. 1, the interlayer constraining layers 9 are defined by the second ceramic green sheets, which contain a ceramic powder that is not substantially sintered at the sintering temperature of the first ceramic green sheets. The interlayer constraining layers 9 are thinner than the ceramic layers 3.

The second ceramic green sheets, which define the interlayer constraining layers 9, may be formed in advance before they are laminated on the first ceramic green sheets, or may be directly formed on the first ceramic green sheets by thick-film printing.

Next, the interlayer connection conductors 6 and the in-plane conductors 7 are formed by the same method as that used in the preferred embodiment shown in FIG. 1, followed by a laminating step.

The unsintered composite laminate 2a is fired to provide the multilayer ceramic substrate 1a shown in FIG. 3(2). In the firing step, the composite laminate 2a is fired at a temperature at which the unsintered ceramic layers 3 and the unsintered interlayer connection conductors 6 and in-plane conductors 7 are sintered but the ceramic powder contained in the interlayer constraining layers 9 is not substantially sintered.

As a result of the firing step, some of the glass component included in the ceramic layers 3 diffuses or flows into the interlayer constraining layers 9, thus binding the ceramic powder included in the interlayer constraining layers 9. In the firing step, the interlayer constraining layers 9 do not substantially contract because the ceramic powder itself is not substantially sintered in the interlayer constraining layers 9. The interlayer constraining layers 9 thus provide a contraction-suppressing effect on the ceramic layers 3 to suppress contraction of the ceramic layers 3 in the main-surface direction. The multilayer ceramic substrate 1a thus produced has high accuracy in terms of dimension and shape. In this preferred embodiment, the interlayer constraining layers 9 are not removed after the firing step but are left in the multilayer ceramic substrate 1.

In the above-described preferred embodiment, the interlayer constraining layers 9 do not have to be provided at all interfaces between the ceramic layers 3. In addition, a surface constraining layer may be formed on at least one main surface of the composite laminate 2a using the same material as the interlayer constraining layers 9. In the firing step, some of the glass component included in the ceramic layers 3 also diffuses or flows into the surface constraining layer, thus binding the powder included in the surface constraining layer. In this case, the surface constraining layer is not removed.

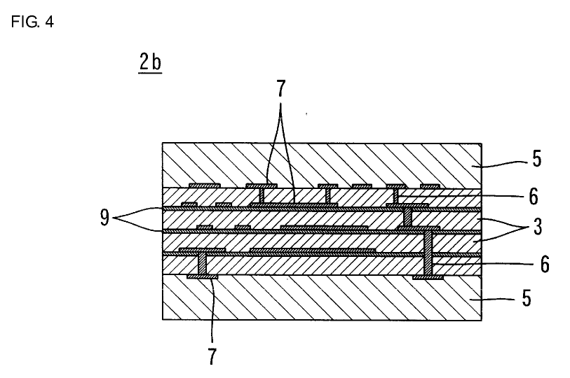

FIG. 4 illustrates another preferred embodiment of the method for producing a multilayer ceramic substrate as an example of a multilayer ceramic electronic component. FIG. 4 is a diagram corresponding to FIGS. 1(1) and 3(1). In FIG. 4, elements corresponding to those shown in FIGS. 1(1) and 3(1) are denoted by the same reference numerals, and redundant description will be omitted.

An unsintered composite laminate 2b shown in FIG. 4 includes both the outer constraining layers 5 and the interlayer constraining layers 9. The remaining structure is substantially the same as those of the preferred embodiments shown in FIGS. 1 and 3.

In the preferred embodiment shown in FIG. 4, the interlayer constraining layers 9 are not removed after the firing step, but the outer constraining layers 5 are removed.

This preferred embodiment provides a multilayer ceramic substrate with higher accuracy in terms of dimension and shape.

While preferred embodiments of the present invention have been described above, it is to be understood that variations and modifications will be apparent to those skilled in the art without departing the scope and spirit of the present invention. The scope of the present invention, therefore, is to be determined solely by the following claims.

What is claimed is:

1. A slurry composition for ceramic green sheets comprising:
a ceramic raw powder including boron and an alkaline earth metal, an acrylic binder component, a β-diketone defining a chelating agent, and an organic solvent; wherein
the content of the β-diketone is about 0.020 to about 0.040 times by weight the total content of boron and the alkaline earth metal in the ceramic raw powder.

2. A ceramic green sheet including the slurry composition according to claim 1.

3. A method for producing a slurry composition for ceramic green sheets, comprising the steps of:
dispersing a ceramic raw powder including boron, an alkaline earth metal, and a β-diketone defining a chelating agent; and
dispersing an acrylic binder component; wherein
the content of the β-diketone is about 0.020 to about 0.040 times by weight the total content of boron and the alkaline earth metal in the ceramic raw powder.

4. A method for producing a multilayer ceramic electronic component, comprising the steps of:
preparing a plurality of ceramic green sheets according to claim 2;
laminating the ceramic green sheets on top of one another to form an unsintered ceramic laminate; and
firing the unsintered ceramic laminate.

5. A method for producing a multilayer ceramic electronic component, comprising the steps of:
preparing first ceramic green sheets according to claim 2;
preparing a second ceramic green sheet including a ceramic powder that is not substantially sintered at a sintering temperature of the first ceramic green sheets;
laminating the first ceramic green sheets on top of one another with the second ceramic green sheet provided on one of the first ceramic green sheets to form an unsintered composite laminate; and
firing the unsintered composite laminate.

6. The method for producing a multilayer ceramic electronic component according to claim 5, wherein the second ceramic green sheet is an outermost layer of the unsintered composite laminate, and the method further comprises a step of removing an unsintered outer constraining layer including the second ceramic green sheet as the outermost layer after the step of firing the unsintered composite laminate.

7. A multilayer ceramic electronic component comprising:
a plurality of ceramic layers stacked on top of one another; wherein
the ceramic layers are defined by ceramic green sheets according to claim 2 that have been sintered.

8. A multilayer ceramic electronic component comprising:
a plurality of ceramic layers stacked on top of one another; wherein
the ceramic layers are defined by ceramic green sheets according to claim 2 that have been sintered; and
the multilayer ceramic electronic component further comprises a constraining layer provided on one of the ceramic layers, the constraining layer including a ceramic powder that is not substantially sintered at a sintering temperature of the ceramic green sheets.
